(19) United States
(12) Patent Application Publication
(10) Pub. No.: US 2019/0193978 A1
(43) Pub. Date: Jun. 27, 2019

(54) SELF-ALIGNING DETECTOR DEVICE

(71) Applicant: SOLYSTIC, Bagneux (FR)

(72) Inventors: Damien Pano, Valence (FR); Christian Duclot, Annonay (FR); Arnaud Vimard, Valence (FR)

(21) Appl. No.: 16/193,663

(22) Filed: Nov. 16, 2018

(30) Foreign Application Priority Data
Dec. 22, 2017 (FR) 1762938

(51) Int. Cl. B65H 29/60; B65H 43/00; G01D 5/14

(52) U.S. Cl. CPC B65H 29/60; B65H 2701/1916; G01D 5/14; B65H 43/00

(57) ABSTRACT

A detector device comprising an activator element (220) and a detector element (210) mounted to move relative to each other, the detector element generating a detection signal by a proximity effect when the activator element is facing it, a swing system with a first lever (212) carrying the detector element (210) and a second lever (222) carrying the activator element (220), said levers being mounted on a common pivot (230) while being offset angularly from each other, the second lever being designed to pivot from a rest position towards the first lever under the effect of thrust until the activator element and the detector element are in alignment, said first and second levers being designed such that, starting from the state of alignment and under the effect of the thrust, the second lever causes the first lever to pivot through a certain angular range.

### TECHNICAL FIELD

The invention relates in particular to a mailpiece sorting machine having sorting outlets with storage devices, each storage device including a recess into which a receptacle comes to be inserted, in which receptacle the sorted mailpieces are stored.

### PRIOR ART

Such a type of machine is used more particularly in postal sorting centers for sorting parcels.

The receptacle of each sorting outlet is generally in the form of a wheeled bin having quite large dimensions.

In order to insert the bin into the recess, an operative wheels it to the far end of the recess into an abutment position.

The switching flap of each sorting outlet should be placed in the position in which it diverts parcels to the bin only when said bin is correctly pushed into the recess.

It has already been observed that the positioning of the bins can vary to a certain extent, it being possible for certain bins to be misaligned relative to the recess.

There therefore exists a need for a sensor that makes it possible to detect the presence of the bin in the recess so as to cause the switching flap to pivot.

In particular, the sensor should allow for a certain amount of tolerance in the positioning of the bin in the recess, while also reliably detecting the correct positioning of the bin in the recess so as to avoid a parcel being able to fall to the floor outside the bin.

Patent application US 2007/0072656 describes an electronic device that can be folded closed by two elements pivoting relative to each other, one of the elements including a magnetic detector.

### SUMMARY OF THE INVENTION

To this end, the invention provides a detector device comprising an activator element and a detector element that are mounted to move relative to each other, the detector element generating a detection signal by a proximity effect when the activator element is facing it, said detector device being characterized in that it further comprises a swing system with a first lever carrying the detector element and a second lever carrying the activator element, said levers being mounted on a common pivot while being offset angularly from each other, the second lever being designed to pivot from a rest position towards the first lever under the effect of thrust and to move angularly closer to the first lever until it reaches a state of alignment in which the activator element and the detector element are in alignment, and in that said first and second levers are designed such that, starting from the state of alignment and under the effect of the thrust, the second lever causes the first lever to pivot through a certain angular range.

With this self-aligning device mounted on the far end plane of the recess, in such a manner that the front face of the bin comes to exert thrust on the second lever when the bin is inserted into the recess, it is possible to obtain reliable detection of the presence of the bin in the recess and in the correct position for receiving the parcels.

In particular, it can be understood that the angular offset of one lever relative to the other requires the bin to be inserted sufficiently deeply into the recess and, at the same time, the possibility for the two levers to pivot through the angular range affords a certain amount of tolerance in the positioning of the bin in the recess, e.g. so that the bin can be positioned askew in the recess.

With this machine, operatives are kept safe without a large amount of investment, by small modifications being made to the equipment, and without any impact on the usual working methods, in particular on the type of receptacles used and on the way in which they are handled; even if the receptacles that are usually used have dimensions and shapes that are poorly defined, and are positioned under the flaps in approximative manner, their presence and their absence can be detected reliably, preventing the flaps from opening at times when that could be dangerous for the operatives and/or could adversely affect the sorting operations.

In addition, by means of the configuration of the detector device, this machine can advantageously use conventional proximity detectors that are reliable, robust, and inexpensive, but that, ordinarily, can be used only for very well defined geometrical shapes, such as, for example, to detect closing of a door.

The invention may advantageously also have the following features:
an abutment may be provided to maintain the first lever angularly offset from the second lever in the rest position;
the second lever may be provided with a tab that is designed to come to bear against the first lever to cause it to pivot through said certain angular range;
the second lever may be urged to return towards its rest position by a return spring;
another abutment may be provided to stop the pivoting of the first lever at the maximum limit of said certain angular range;
said second lever may hang substantially vertically in the rest position; and
the proximity effect may be a magnetic effect.

The invention may also provide:
a storage device that may include a frame forming a recess having a far end plane and into which a storage receptacle can be inserted, said storage device being characterized in that it includes a detector device of the invention, said detector device being mounted on the far end plane of the recess, said receptacle having a front face suitable for exerting said thrust on the second lever when the receptacle is inserted in the recess; and
a mailpiece sorting machine characterized in that it may include sorting outlets, each of which has a storage device of the invention, and a switching flap for diverting mailpieces into the storage device, the flap being controlled on the basis of said detection signal.

### BRIEF DESCRIPTION OF THE DRAWINGS

The present invention can be better understood and other advantages appear on reading the following detailed description of an embodiment given by way of non-limiting example and with reference to the accompanying drawings, in which:

FIG. 1A is a diagrammatic fragmentary view of an example of a sorting machine of the invention with receptacles in the loading positions;

FIG. 1B shows a detector device of the invention, how it is incorporated into the sorting machine of FIG. 1A, and how it is positioned relative to a receptacle;

FIG. 2A is a perspective view of the detector device of FIG. 1B;

FIG. 2B shows how the detector device of FIG. 1B operates;

FIG. 3 is a block diagram showing the functional relationships between the elements that operate the sorting machine that is shown in FIG. 1A and that includes the detector device 1B; and

FIG. 4 is a fragmentary view of a storage device of the invention, and of how the detector device of FIG. 1B is incorporated into this storage device.

### DESCRIPTION OF AN EMBODIMENT

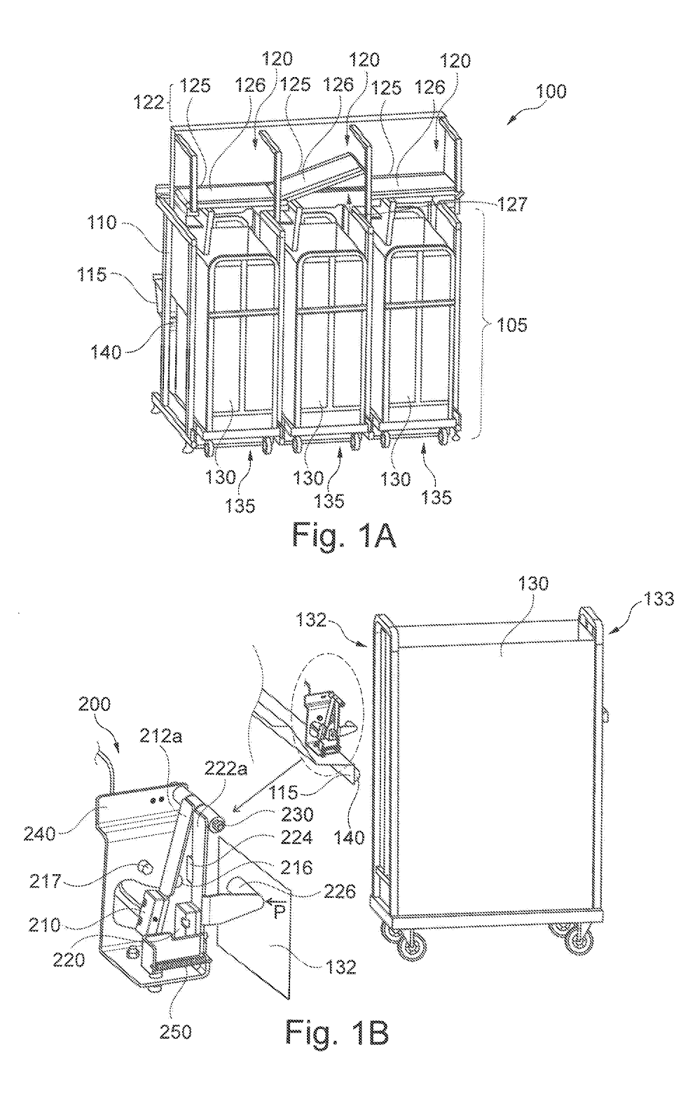

A mailpiece sorting machine 100 including a storage device 105 and a detector device of the invention is shown in FIGS. 1A to 4.

Ordinarily, the sorting machine 100 shown in FIG. 1A is incorporated into a sorting installation in which mailpieces to be sorted are received, and then disposed on a conveyor that brings them to a sorting conveyor 122 that is incorporated into the sorting machine 100 and that has sorting outlets 125.

During operation, operatives put receptacles 130 into loading positions in the storage device 105 under the sorting conveyor 120, towards which receptacles the sorting machine directs the mailpieces to be sorted that are brought to it.

The receptacles 130 are suitable for being changed during the sorting, and they may be wheeled trolleys such as the ones shown in FIGS. 1A and 1B, or any other container suitable for receiving objects, such as cardboard boxes, dropping from the conveyor.

In order to ensure that the sorting operations take place properly and also for safety reasons, a sorting machine of the invention includes detector devices 200 that make it possible to detect whether or not receptacles are present under the sorting conveyor 120.

The sorting conveyor 122 is made up of flaps 125, each of which comprises a conveyor belt 126 for conveying the mailpieces and for keeping the sorting outlets 125 closed when the respective flaps are in the closed position.

Each of the flaps 125 can pivot to an open position to form an opening 127 in the conveyor 120 in such a manner as to allow mailpieces to drop under the sorting conveyor 122, into the corresponding receptacle 130.

A frame 110 forms the storage device 105 that can support the sorting conveyor 122 and that defines a recess 135 for a receptacle under each of the flaps 125, in such a manner that each receptacle 130 put in the loading position in one of the recesses can receive parcels dropping from the sorting conveyor 120 after the flap 125 overlying it has been opened.

The flaps are controlled by a monitoring and control system 260 that is configured to open and to close the flaps in compliance with a sorting plan that indicates an outlet, and therefore a destination receptacle, for each mailpiece to be sorted.

For example, the sorting plan may be recorded in a computer memory 265 that is in functional communication with the monitoring and control system.

The monitoring and control system is also functionally connected to the detector devices 200 for detecting the presence of the receptacles under the flaps, and has a safety function that consists in stopping from opening each flap under which the presence of a receptacle in the loading position is not detected.

Each detector device 200 is incorporated into a far end plane (136) of a recess of the storage device 105, and is configured to send detection signals to the monitoring and control system indicating that the presence of a receptacle in said recess has been detected.

Each flap is associated with one of the detector devices, each of which is fastened to a fastening plate 240 mounted on an element 115 of the frame in the far end plane of a recess and extending in such a manner as to be adjacent to the front faces 132 of receptacles in the loading positions in the recesses 135.

The detector devices are also configured in such a manner that a receptacle put in place in a recess by pushing on its rear face 133 causes a detection signal to be sent by one of the detector devices.

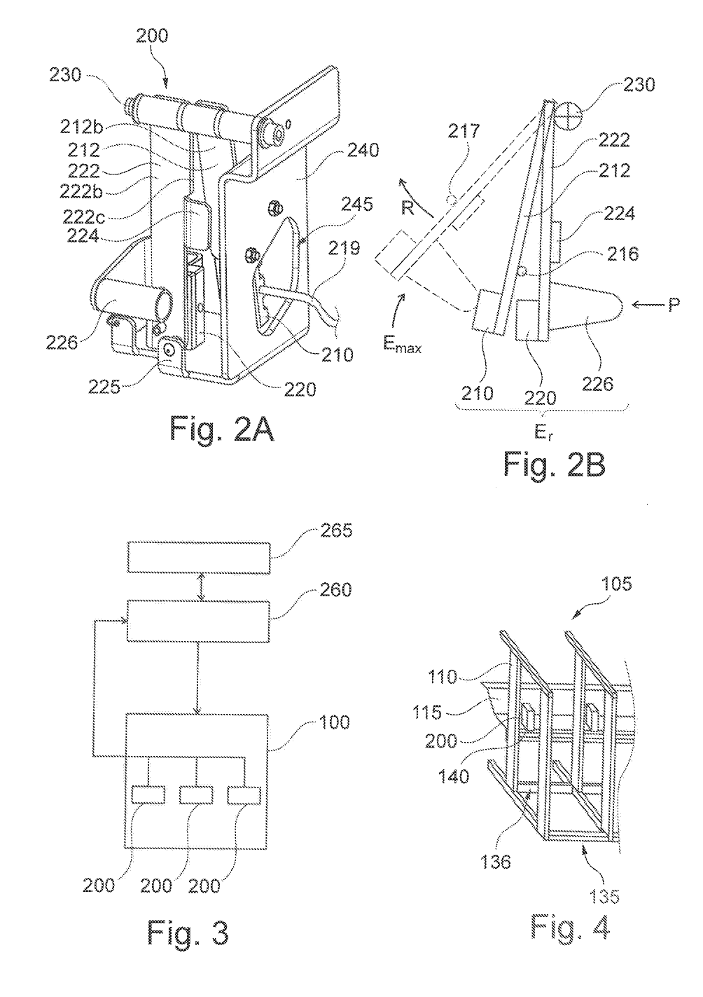

A detector device 200, shown in FIGS. 1B, 2A, and 2B, is based on using a conventional proximity sensor that is made up of two elements 210 and 220 that are, respectively, a detector element 210 and an activator element 220 having the function of activating the detector element by a proximity effect when the two elements are facing each other a short distance apart.

For example, the proximity effect of such a sensor may be a magnetic effect, a capacitive effect, or an inductive effect.

The two elements of the sensor are mounted on a swing system having two levers, the detector element being mounted on a front face 212a of a first lever 212 and the activator element being mounted on a front face 222a of a second lever 222.

The two levers are arranged to pivot about a common pivot axis 230, or pivot 230, mounted transversely on the fastening plate 240, the first lever 212 being interposed between the fastening plate and the second lever 222.

The two elements of the proximity sensor are situated substantially at the same distance from the pivot, and the levers are close enough together for the activator element to activate the detector element when they are facing each other.

The plate 240 and the axis 230 are situated and oriented in such a manner that putting a receptacle into place in a loading position in any given recess causes the levers of the corresponding detector device to be driven in rotation R by thrust P, as indicated in FIGS. 1B and 2B.

A first abutment 216 and a second abutment 217 extend parallel to the axis 230 from the plate 240, and are long enough to stop movement in rotation of at least the first lever, the first abutment 216 being short enough so as to not to stop movement in rotation of the second lever.

When the device is in a rest state Er, said levers are offset angularly from each other, as can be seen in FIGS. 1B and 2B.

More precisely, the first lever 212 is inclined, its rear face 212b being in contact with the first abutment 216 that stops its movement in rotation, while the second lever 222 is in a rest position that is lower than the first lever, e.g. so that said second lever hangs substantially vertically from the pin 230.

When the device is in the state Er, and because of the angular offset between the levers due to the abutment 216, the two elements of the sensor are in a state of non-alignment, i.e. they do not face each other, and the activator element cannot activate the detector element.

A drive tab 224 extends from the second lever and is configured so that the second lever 222 drives the first lever 212 in rotation by pushing it on its rear face 212b.

More precisely, the drive tab 224 extends towards the fastening plate 240 from a side 222c of the second lever 212 that faces the fastening plate 240, in such a manner as to come into contact with the rear face 212b of the first lever 212.

The tab 224 is provided with a shoulder so that, when the tab is in contact with the rear face of the first lever 212, the two levers are aligned with each other, or are superposed, as seen looking along the pin 230, and the two elements 210 and 220 of the sensor are also aligned with each other and face each other.

When the device is in a state Emax, the front face 212a of the first lever is in contact with the second abutment 217 and its rear face 212b is in contact with the drive tab 224 of the second lever.

In the state Emax, the levers 212 and 222 and the elements 212 and 222 of the sensor are mutually aligned, respectively, FIG. 2B showing the state when, in the view of the figure, the levers and the elements of the sensor, in dashed lines, are superposed.

An actuator member 226 extends from the second lever 222 rearwards from it into the volume of a recess 135, the actuator member being designed in such a manner as to transmit to the second lever 222 thrust P from a receptacle 130 put in place in said recess.

The actuator member may have any shape whatsoever, but it is preferably adapted to the type of receptacle that is used, and is not limited to the shape shown in the figures.

The state Emax corresponds to an amplitude of maximum rotation of the levers that is obtained after thrust has been exerted on the second lever 222 and after the first lever 212 has been driven in rotation by the drive tab 224 of the second lever 222.

A return spring 250 may be fastened between the fastening plate 240 and the second lever 222 in such a manner as to return said second lever to the low position after it has been moved by the thrust P of the receptacle 130.

The spring is not strictly necessary for the second lever 222 to return to the low position, gravity alone normally being sufficient to bring the lever back to this position, but the spring provides a backup if an unforeseen or undetected difficulty arises, such as, for example, movement in rotation about the pivot axis 230 being prevented by corrosion, making gravity alone insufficient for pivoting the lever into its rest position.

A tab 225 may extend from the fastening plate 240 to impose a given rest position to the second lever 222.

A third abutment 140, fastened to the element 115 of the frame, extends horizontally at the far end of each of the recesses 135 to stop the receptacles 135 from advancing any further when they are pushed into the recesses in order to be put into loading positions under the flaps, in such a manner as not to bring the first lever and/or the second lever into contact with the second abutment 217 by direct thrust, which could damage the device.

The second abutment 217 serves to stop the movement in rotation of the first lever 212 in the event it continues to move in rotation by an inertia effect after a receptacle has been put into place in a recess, and thereby prevents pinching of an electrical power and/or monitoring cable 219 extending from the detector element 210 and passing through an opening 245 in the fastening plate 240.

During operation, in the situation in which the recess of the given receptacle is empty, the corresponding detector device is in the rest state Er, the elements of the detector 200 are in the non-aligned state, no detection signal indicating detection of the presence of a receptacle is sent, and the corresponding flap is locked in the closed position.

Starting from this situation, when a receptacle 130 is put in place manually by an operative in a recess 135, the receptacle pushes the second lever 222 of a given detector device 200 via its actuator member 226, and causes it to pivot from its rest position so that it moves angularly closer to the first lever 210 until a state of alignment is reached in which the activator element and detector element are in alignment.

The first and second levers are designed so that, starting from this state of alignment, and under the effect of the thrust, the second lever causes the first lever to pivot through a certain angular range.

More particularly, while the second lever 222 is moving in rotation, the tab 224 comes into initial contact with the first lever 212 that is in contact with the abutment 216, and then drives said first lever in rotation when the second lever continues to move in rotation.

Starting from the initial contact and so long as the contact between the tab and the first lever is maintained, the two elements 210 and 220 of the sensor are aligned with each other, and a receptacle detection signal is sent to the monitoring and control system that responds by authorizing opening of the flap corresponding to the given detector device.

An order to open the flap is sent to the sorting machine by the monitoring and control unit only if the following two conditions are satisfied simultaneously: 1) a detection signal indicating that a receptacle has been detected is received and 2) a parcel to be caused to drop into said receptacle arrives at the corresponding flap.

In this way, the absence of a receptacle in any given recess stops the corresponding flap from being opened, thereby firstly ensuring that the sorting operations take place properly and secondly preventing any risk related to movement of the flap for the operatives who, in the absence of the receptacle, have direct access to the flap.

A receptacle detection signal may be sent continuously so long as the detector element and the activator element are mutually aligned, or a plurality of detection signals may be sent at time intervals that are short enough for withdrawal of the receptacle to be detected quickly enough not to have any impact on the sorting operations and/or not to compromise the safety of the operatives.

Since the drive tab maintains the two detector elements in alignment through a certain angular range of rotation of the levers, or indeed through a range of rotation of the second lever as pushed by the receptacle, the detection signal indicating the receptacle has been detected can be sent independently of the exact position of the receptacle in its recess, when the device is in any state whatsoever between a state in which the initial contact takes place between the tab 224 and the first lever 212 in contact with the abutment 216 and the state Emax in which the amplitude of maximum rotation of the levers is reached.

Thus, the above-described mechanical device enables two elements making up a proximity detector to be aligned automatically, thereby constituting a self-aligning detector device.

When the receptacle is withdrawn from its recess in order to be replaced, gravity and the spring 250 return the device to its state Er, thereby interrupting sending of a positive detection signal indicating that the receptacle has been positively detected, and the flap is locked in the closed position until a receptacle is again placed in the recess as described above.

1. A detector device comprising an activator element and a detector element that are mounted to move relative to each other, the detector element generating a detection signal by a proximity effect when the activator element is facing it, said detector device further comprising a swing system with a first lever carrying the detector element and a second lever carrying the activator element, said levers being mounted on a common pivot while being offset angularly from each other, the second lever being configured to pivot from a rest position towards the first lever under the effect of thrust and to move angularly closer to the first lever until it reaches a state of alignment in which the activator element and the detector element are in alignment, and in that said first and second levers are configured such that, starting from the state of alignment and under the effect of the thrust, the second lever causes the first lever to pivot through a certain angular range.

2. The detector device according to claim 1, wherein an abutment is provided to maintain the first lever angularly offset from the second lever in the rest position.

3. The detector device according to claim 2, wherein the second lever is provided with a tab that is designed to come to bear against the first lever to cause it to pivot through said certain angular range.

4. The detector device according to claim 3, wherein the second lever is urged to return towards its rest position by a return spring.

5. The detector device according to claim 4, wherein another abutment is provided to stop the pivoting of the first lever at the maximum limit of said certain angular range.

6. The detector device according to claim 5, wherein said second lever hangs substantially vertically in the rest position.

7. The detector device according to claim 6, wherein the proximity effect is a magnetic effect.

8. A storage device comprising:
a frame forming a recess having a far end plane and into which a storage receptacle can be inserted, said storage device; and
a detector device having an activator element and a detector element that are mounted to move relative to each other, the detector element generating a detection signal by a proximity effect when the activator element is facing it, said detector device further comprising a swing system with a first lever carrying the detector element and a second lever carrying the activator element, said levers being mounted on a common pivot while being offset angularly from each other, the second lever being configured to pivot from a rest position towards the first lever under the effect of thrust and to move angularly closer to the first lever until it reaches a state of alignment in which the activator element and the detector element are in alignment, and in that said first and second levers are configured such that, starting from the state of alignment and under the effect of the thrust, the second lever causes the first lever to pivot through a certain angular range,
said detector device being mounted on the far end plane of the recess, and
said receptacle having a front face suitable for exerting said thrust on the second lever when the receptacle is inserted in the recess.

9. A mailpiece sorting machine comprising:
sorting outlets each of which has a storage device having a frame forming a recess having a far end plane and into which a storage receptacle can be inserted, said storage device; and
a detector device having an activator element and a detector element that are mounted to move relative to each other, the detector element generating a detection signal by a proximity effect when the activator element is facing it, said detector device further comprising a swing system with a first lever carrying the detector element and a second lever carrying the activator element, said levers being mounted on a common pivot while being offset angularly from each other, the second lever being configured to pivot from a rest position towards the first lever under the effect of thrust and to move angularly closer to the first lever until it reaches a state of alignment in which the activator element and the detector element are in alignment, and in that said first and second levers are configured such that, starting from the state of alignment and under the effect of the thrust, the second lever causes the first lever to pivot through a certain angular range,
said detector device being mounted on the far end plane of the recess, and
said receptacle having a front face suitable for exerting said thrust on the second lever when the receptacle is inserted in the recess, and
a switching flap for diverting mailpieces into the storage device, the flap being controlled on the basis of said detection signal.

10. The detector device according to claim 1, wherein the second lever is provided with a tab that is designed to come to bear against the first lever to cause it to pivot through said certain angular range.

11. The detector device according to claim 3, wherein the second lever is urged to return towards its rest position by a return spring.

12. The detector device according to claim 1, wherein another abutment is provided to stop the pivoting of the first lever at the maximum limit of said certain angular range.

13. The detector device according to claim 1, wherein said second lever hangs substantially vertically in the rest position.

14. The detector device according to claim 1, wherein the proximity effect is a magnetic effect.
